(19) United States
(12) Patent Application Publication
(10) Pub. No.: US 2008/0025699 A1
(43) Pub. Date: Jan. 31, 2008

(54) Information processing device and information processing method

(75) Inventor: Kazuhiro Takashima, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/878,990

(22) Filed: Jul. 30, 2007

(30) Foreign Application Priority Data
Jul. 31, 2006 (JP) 2006-208697

(51) Int. Cl. H04N 5/91

(52) U.S. Cl. 386/96; 386/E05.009

(57) ABSTRACT

According to one embodiment, there is provided an information processing device including a storage section which stores a moving image file in a storage area, a determining section which determines whether audio information which can be extracted and reproduced is included in the moving image file, and a creating section which extracts the audio information from the moving image file so as to create an audio file when the determining section determines that the audio information which can be extracted and reproduced is included in the moving image file.

### CROSS-REFERENCE TO RELATED APPLICATIONS

This application is based upon and claims the benefit of priority from Japanese Patent Application No. 2006-208697, filed Jul. 31, 2006, the entire contents of which are incorporated herein by reference.

### BACKGROUND

1. Field

One embodiment of the invention relates to an information processing device and an information processing method which extract audio information in a moving image file and create an audio file so as to reproduce the audio file using a reproducing device.

2. Description of the Related Art

Recently, digital devices have been widely used, and portable audio devices enable audio data of hundreds of songs to be freely carried. Such portable audio devices generally capture audio files as digital data of CD (Compact Disc) into a storage section of a main body so as to reproduce them. In such portable audio devices, audio files are provided by communicable PCs (Personal Computer) or the like in most cases.

Patent Document 1 (Jpn. Pat. Appln. KOKAI Publication No. 2002-56649) discloses a data reproducing device which reads and acquires a moving image file which can be reproduced by a portable audio device from a storage area of another device so as to reproduce the file.

The conventional art in Patent Document 1, however, refers to only the case where reproducible contents files are simply acquired from another device. Therefore, in the case where a reproducing device can reproduce only audio files and only a moving image file is present in an external device, even if the moving image file contains audio information, the reproducing device cannot reproduce the audio.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating one example of a constitution of an information processing system including a reproducing device and an information processing device (PC) according to one embodiment of the present invention;

FIG. 2 is an outline view illustrating one example of an outline of the reproducing device according to one embodiment of the present invention;

FIG. 3 is a flowchart illustrating one example of a file converting process of the information processing device according to one embodiment of the present invention; and

FIG. 4 is a flowchart illustrating another example of the file converting process of the information processing device according to one embodiment of the present invention.

### DETAILED DESCRIPTION

Various embodiments according to the invention will be described hereinafter with reference to the accompanying drawings. In general, according to one embodiment of the invention, an information processing device comprising: a storage section which stores a moving image file in a storage area; a determining section which determines whether audio information which can be extracted and reproduced is included in the moving image file; and a creating section which extracts the audio information from the moving image file so as to create an audio file when the determining section determines that the audio information which can be extracted and reproduced is included in the moving image file.

One embodiment of the present invention provides an information processing device and an information processing method which create an audio file of a file format reproducible by a reproducing device when a moving image file contains audio information.

One of the means for achieving the above object is an information processing device (20) comprising:

a storage section (23) which stores a moving image file in a storage area;

a determining section (22: S13) which determines whether audio information which can be extracted and reproduced is included in the moving image file; and

a creating section (18) which extracts the audio information from the moving image file so as to create an audio file when the determining section determines that the audio information which can be extracted and reproduced is included in the moving image file.

As a result, in PC devices or the like, when a moving image file contains audio information reproducible by a reproducing device, the audio information is extracted and an audio file is created to be provided, so that the reproducing device can reproduce the audio file.

An embodiment of the present invention will be described in detail below with reference to the drawings.

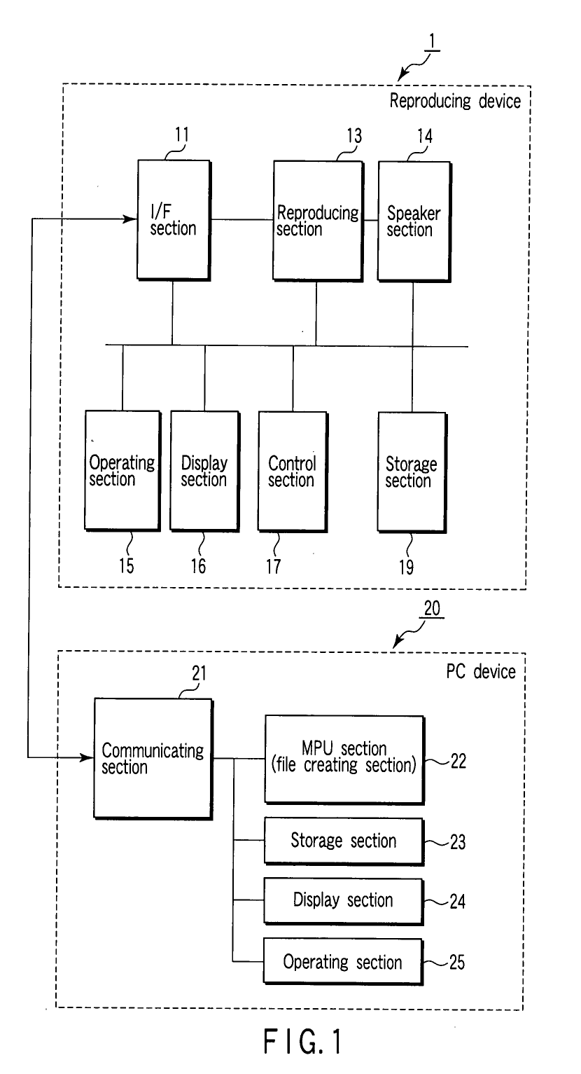

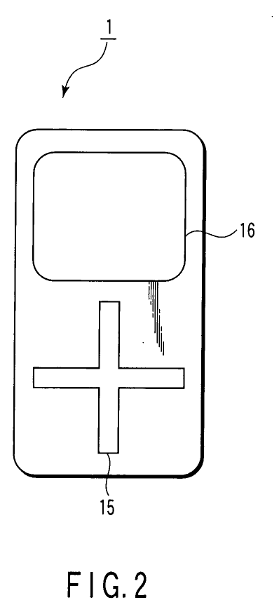

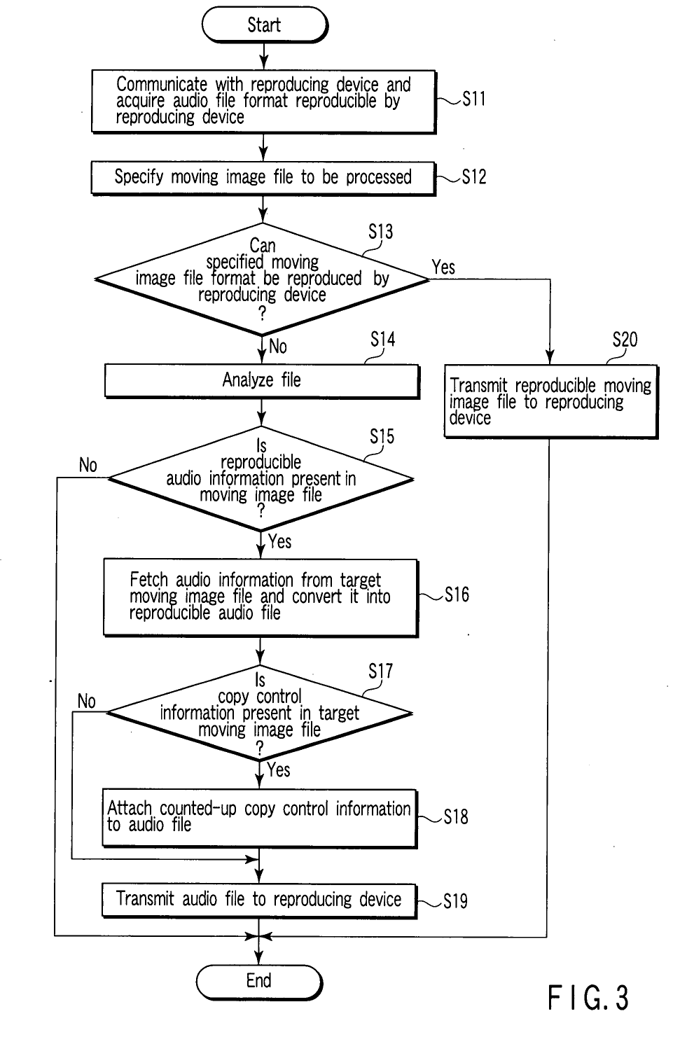

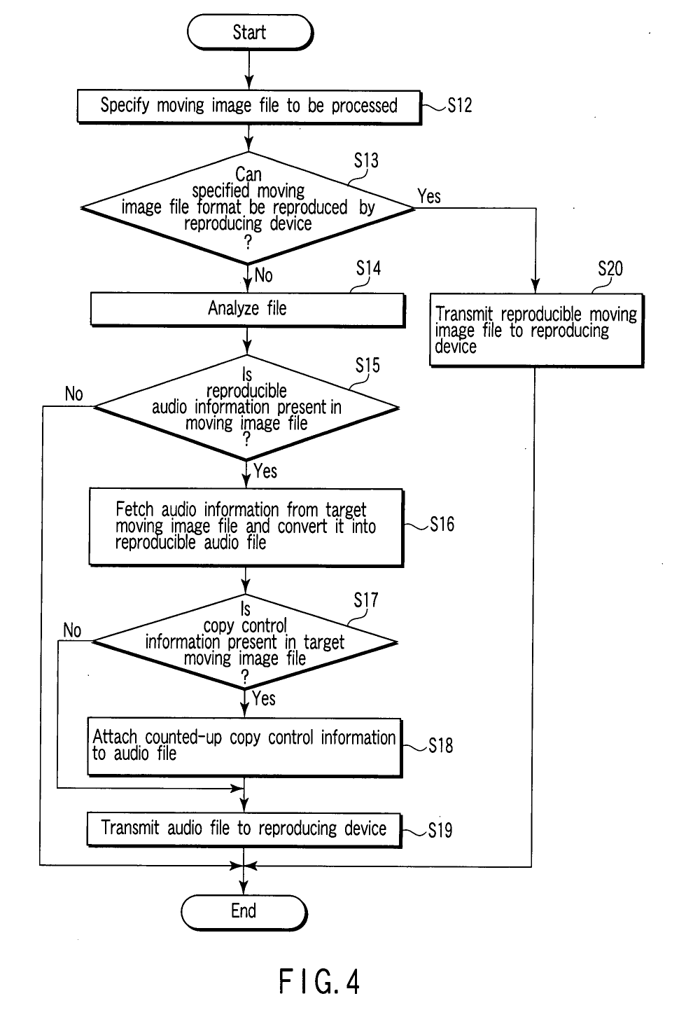

FIG. 1 is a block diagram illustrating one example of a constitution of an information processing system including a reproducing device and an information processing device (PC) according to one embodiment of the present invention. FIG. 2 is an outline view illustrating one example of an outline of the reproducing device according to one embodiment of the present invention. FIG. 3 is a flowchart illustrating one example of a file converting process of the information processing device according to one embodiment of the present invention. FIG. 4 is a flowchart illustrating another example of the file converting process of the information processing device according to one embodiment of the present invention.

The information processing device (PC) according to one embodiment of the present invention is a program application which is installed into the PC device so as to be realized as an execution file stored in CD (Compact Disc) as an accessory of the reproducing device such as an MP3 player. As one example, a user purchases a reproducing apparatus which is an MP3 player, installs CD as its accessory into a PC device so as to actuate the application. The information processing device according to one embodiment of the present invention is used as the application.

An information processing device 1 as the application in the PC device extracts only audio information of WMV (Windows (registered trademark) Media Video) serving as a moving image file stored in a PC device 20, and converts the audio information into WMA (Windows (registered trademark) Media Audio) as an audio file capable of being reproduced by the reproducing device. The file format to be handled is not limited to this.

The information processing device 20 as the application in the PC device and the reproducing device 1 will be described in detail below with reference to the drawings.

### Reproducing Device According to One Embodiment of the Present Invention

(Constitution and Operation)

A constitution of the reproducing device 1 will be described first with reference to FIGS. 1 and 2. The reproducing device 1 of this embodiment has an I/F section 11, a reproducing section 13, a speaker section 14, a control section 17 and a storage section 19. The I/F section 11 establishes communication using wireless LAN standard 802.11a, UWB (Ultra Wide Band), Ethernet (registered trademark), or Bluetooth (registered trademark). The reproducing section 13 reproduces moving image contents data or audio contents data using coding systems such as MP3 (MPEG Audio Layer-3), MP2 (MPEG audio layer-2), MPEG (Moving Picture Experts Group), SBC (Sub Band Codec), WMA (Windows (registered trademark) Media Audio), or AC-3 (Audio Code number 3). The speaker section 14 reproduces audio contents data. The control section 17 controls entire operation. The storage section 19 stores contents data or the like therein. The reproducing device 1 has an operating section 15 and a display section 16. The operating section 15 is composed of an arrow key as one example for various operations of a player device by a user. The display section 16 displays moving image contents and operation information including contents tag information such as album names.

In the reproducing device 1, the control section 17 receives an operating signal from the operating section 15 according to a user's operation, and the reproducing section 13 decodes contents data such as audio data and moving image data acquired via the I/F section 11 under the control by the control section 17. A moving image or the like as the contents data is reproduced on the display section 16 such as a liquid crystal screen, and audio data are reproduced by the speaker section 14 or an earphone, not shown.

As mentioned later, when the information processing device requests a reproducible file format, the reproducible file format information stored in the storage section 19 is transmitted to the information processing device 20 via the I/F section 11 according to the operation of the control section 17.

### Information Processing Device According to One Embodiment of the Present Invention

(Constitution and Operation)

The information processing device (PC) according to one embodiment of the present invention is a program application which is installed into the PC device 20 as an execution file stored in CD (Compact Disc) as an accessory of a reproducing device such as an MP3 player so as to be realized. As an example, a user purchases the reproducing device which is the MP3 player, installs the CD as its accessory into the PC device so as to actuate the application. The information processing device according to one embodiment of the present invention is used as the application.

The information processing device according to one embodiment of the present invention is not limited to the PC device, and may be a digital information processing device in which a file creating function is provided as a dedicated device in advance.

The case where the execution file stored in CD (Compact Disc) as the accessory of the reproducing device such as the MP3 player is installed into the PC device so as to be realized will be described as an example.

The PC device 20 has the reproducing device 1, a communication section 21, an MPU (Micro Processor Unit) section 22, a storage section 23 such as a hard disc drive, a display section 24 such as a liquid crystal display, and an operating section 25 such as a keyboard and a mouse. The communication section 21 adopts a communication standard such as USB (Universal Serial Bus), Ethernet (registered trademark), IEEE1394 or wireless LAN. The MPU section 22 specifies a function according to the flowcharts in FIGS. 3 and 4 and has the file creating function. The storage section 23 stores application programs having OS (Operating System) and the file creating function, and moving image files of various formats such as WMV (Windows (registered trademark) Media Video) therein. The display section 24 visually displays information to a user.

The PC device 20 is a very versatile computer device, for example, but may be a single-function information processing device having an application function such as the above-described file creating function.

(File Creating Function)

The PC device 20 has the file creating function shown in the flowcharts of FIGS. 3 and 4. The steps in the flowcharts of FIGS. 3 and 4 can be replaced by a circuit block, and thus all the steps in the flowcharts can be redefined as blocks.

That is to say, in a state that the application having the file creating function is being actuated, the PC device 20 communicates with the reproducing device 1, and acquires a file format reproducible by the reproducing device 1 from the reproducing device 1 (step S11). When the PC device 20 requests the reproducible file format, the reproducing device 1 transmits information about the file format to the PC device 20 according to the operations of the control section 17 and the storage section 19.

Examples of the audio files reproducible by the reproducing device 1 are WMA (Windows (registered trademark) Media Audio), MP3 (MPEG Audio Layer-3), AC-3 (Audio Code number 3), and MP2 (MPEG Audio Layer-2). A moving image file to be processed is specified from files stored in the storage section 23 by user's operation of the operating section 25 such as a mouse (step S12). Preferable examples of the moving image file format are WMV (Windows (registered trademark) Media Video), ASF (Advanced Streaming Format), and MPEG2.

A determination is made whether the specified file format can be reproduced by the reproducing device 1 based on the file format information acquired at step S11 (step S13). It is desirable that information of the application includes reproducible or convertible file formats.

If a moving image file specified by the user can be reproduced by the reproducing device 1 without being converted, the moving image file is transmitted immediately to the reproducing device (step S20).

If the moving image file specified by the user cannot be reproduced by the reproducing device 1, the MPU section 22 analyzes the file (step S14). A determination is made whether the moving image file specified by the user includes reproducible audio information (step S15).

When the audio information is not present, the process is ended immediately. When the reproducible audio information is present, audio information is extracted from the target file, and the reproducible audio file is converted into a file format specified by the user or a default file format (step S16).

A determination is made whether the specified moving image file includes copy control information (step S17). When the copy control information is present, the current converting process is determined as once copy process, for example, and copy control information in which once copy process is counted (updated) is created so as to be attached to the audio file (step S18). The audio file is transmitted to the reproducing device 1 (step S19). When the copy control information is not present, the audio file is transmitted immediately to the reproducing device 1 (step S19).

As a result, the reproducing device 1 extracts only audio information of the moving image file which cannot be reproduced, and reproduces it as a reproducible audio file.

One example of combination of the moving image file and the audio file to be processed will be described below.

First, WMV (Windows (registered trademark) Media Video) of a moving image file is desirably converted into WMA (Windows (registered trademark) Media Audio) of an audio file or MP3 (MPEG Audio Layer-3) of an audio file.

ASF (Advanced Streaming Format) of the moving image file is desirably converted into MP3 of the audio file.

It is desirable that MPEG 2 of a moving image file is converted into AC-3 (Audio Code number 3) of an audio file or MP2 (MPEG Audio Layer-2) of an audio file.

The process that “the information processing device 20 communicates with the reproducing device 1 and acquires a file format reproducible by the reproducing device” in the flowchart of FIG. 3 is not always required, and this process can be omitted as shown in the flowchart of FIG. 4. In this case, it is desirable that the file format information is stored as application data in advance.

According to the information processing device 20 in this embodiment of the present invention, as the function of the information processing device 20, audio information is extracted even from a moving image file whose format cannot be reproduced by the reproducing device 1, and a reproducible audio file is created so as to be transmitted to the reproducing device 1. As a result, audio information of various formats can be reproduced.

According to various embodiments, a person skilled in the art can realize the present invention, and can easily conceive of various modified examples of the embodiment. As a result, the present invention can be applied to various embodiments without an inventive ability. Therefore, the present invention covers a wide range without departing from the disclosed principles and novel features, and thus is not limited to the above-mentioned embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a storage section which stores a moving image file in a storage area;
a determining section which determines whether audio information which can be extracted and reproduced is included in the moving image file; and
a creating section which extracts the audio information from the moving image file so as to create an audio file when the determining section determines that the audio information which can be extracted and reproduced is included in the moving image file.

2. The information processing device according to claim 1, wherein when the moving image file contains copy control information, the creating section updates the copy control information so as to allow it to be included in the audio file.

3. The information processing device according to claim 1, wherein the creating section communicates with an external reproducing device for reproducing the audio file, and acquires a file format reproducible by the reproducing device so as to create an audio file of this reproducible format based on the extracted audio information.

4. The information processing device according to claim 1, further comprising a communicating section which transmits the audio file created by the creating section to an external reproducing device which reproduces the audio file.

5. An information processing method comprising:
determining whether audio information which can be extracted and reproduced is included in a moving image file; and
extracting the audio information from the moving image file so as to create an audio file when the determination is made that the audio information is included in the moving image file.

6. The information processing method according to claim 5, wherein when the moving image file contains copy control information, the copy control information is updated so as to be included in the audio file.

7. The information processing method according to claim 5, wherein communication with an external reproducing device for reproducing the audio file is performed, a file format reproducible by the reproducing device is acquired, and an audio file of this reproducible format is created based on the extracted audio information.

8. The information processing method according to claim 5, wherein the created audio file is transmitted to an external reproducing device which reproduces the audio file.
